(19) United States
(12) Patent Application Publication
(10) Pub. No.: US 2005/0038788 A1
(43) Pub. Date: Feb. 17, 2005

(54) Annotation security to prevent the divulgence of sensitive information

(75) Inventors: Richard D. Dettinger, Rochester, MN (US); Cale T. Rath, Byron, MN (US); Richard J. Stevens, Mantorville, MN (US)

Correspondence Address: William J. McGinnis, Jr.;IBM Corporation, Dept. 917, 3605 Highway 52 North, Rochester, MN, 55901-7829, US

(73) Assignee: International Business Machines Corporation, Armonk, NY (US)

(21) Appl. No.: 10/640,814

(22) Filed: Aug. 14, 2003

(51) Int. Cl. G06F 17/00

(52) U.S. Cl. 707/10

(57) ABSTRACT

Methods, systems, and articles of manufacture that may be used to prevent sensitive information from being divulged in an annotation are provided. Upon creation, modification and/or retrieval of an annotation, a set of predefined security rules may be applied to the annotation, in an effort to detect sensitive information contained therein. Upon detecting sensitive information in an annotation, appropriate security measures may be taken, such as notifying a user creating, modifying, or retrieving the annotation (e.g., prompting the user to modify annotation to remove the sensitive information), preventing entry of the annotation, and/or notifying appropriate personnel in charge of security, such as a system administrator.

### CROSS-REFERENCE TO RELATED APPLICATIONS

The present application is related to commonly-owned U.S. Pat. No. 6,519,603, entitled “Method And System For Organizing An Annotation Structure And For Querying Data And Annotations”, commonly-owned, co-pending application Ser. No. 10/083,075, entitled “Application Portability And Extensibility Through Database Schema And Query Abstraction”, filed Feb. 26, 2002 (Attorney Docket No. ROC920020044US1), and commonly owned co-pending application Ser. No. 10/600,014, entitled “Universal Annotation Management System,” filed Jun. 20, 2003 (Attorney Docket No. ROC920030209US1), and commonly owned co-pending application Ser. No. 10/600,382, entitled “Heterogeneous Multi-Level Extendable Indexing For General Purpose Annotation Systems,” filed Jun. 20, 2003 (Attorney Docket No. ROC920030127US1), which are herein incorporated by reference.

### BACKGROUND OF THE INVENTION

1. Field of the Invention

The present invention relates to the field of data entry and retrieval and, more particularly, to a method and system for providing security measures to prevent the unauthorized or unintentional inclusion of sensitive information in annotations.

2. Description of the Related Art

There are well known methods for capturing and storing explicit knowledge as data, for example, in relational databases, documents, flat files, and various proprietary formats in binary files. Often, such data is analyzed by various parties (e.g., experts, technicians, managers, etc.), resulting in rich interpretive information, commonly referred to as tacit knowledge. However, such tacit knowledge is often only temporarily captured, for example, as cryptic notes in a lab notebook, discussions/conversations, presentations, instant messaging exchanges, e-mails and the like. Because this tacit knowledge is typically not captured in the application environment in which the related data is viewed and analyzed, it is often lost.

One approach to more permanently capture tacit knowledge is to create annotations containing descriptive information about data objects. Virtually any identifiable type of object may be annotated, such as a matrix of data (e.g., a spreadsheet or database table), a text document, or an image. Further, subportions of objects (sub-objects) may be annotated, such as a cell, row, or column in a database table or a section, paragraph, or word in a text document. An indexing scheme is typically used to map each annotation to the annotated data object or sub-object, based on identifying information, typically in the form of an index. The index should provide enough specificity to allow the indexing scheme to locate the annotated data object (or sub-object). Further, to be effective, the indexing scheme should work both ways: given an index, the indexing scheme must be able to locate the annotated data object and, given an object, the indexing scheme must be able to calculate the index for use in classification, comparison, and searching (e.g., to search for annotations for a given data object).

One potential problem, however, presented when capturing and sharing information in annotations, is the unauthorized or unintentional divulgence of sensitive information. It is possible that the person creating the annotation (i.e., the author) may include in the annotation sensitive information that may, in some cases, compromise the privacy of an individual. In other words, the annotation may be made available to subsequent viewers, not typically authorized to view the sensitive information contained therein.

As an example, in a business environment, a manager may have the authority to create annotations about information contained in personnel records. Subsequent viewers of the annotation (e.g., accounting personnel determining salary adjustments or bonuses) may be prevented from viewing portions of the records that identity the corresponding employee, such as the employee's name or ID. However, this information may be unwittingly included in the annotation compromising that employee's privacy. For example, the manager may view a performance indicator in an employee's record and create an annotation with the comment ‘Mr. Smith's performance is down from last year’, thus compromising Mr. Smith's private information to others allowed to view the annotation, even if they are not allowed to otherwise see the identifying information (thus divulging the employee to whom the performance indicator corresponds). In effect, the annotated field (the performance indicator) has been contaminated with sensitive information (the employees name) via the annotation.

Accordingly, there is a need for improved methods and systems for preventing unauthorized or unintentional divulgence of sensitive information in the form of annotations.

### SUMMARY OF THE INVENTION

The present invention generally is directed to methods, systems, and articles of manufacture for preventing the divulgence of sensitive information in annotations.

One embodiment provides a method of preventing sensitive information from being divulged in annotations. The method generally includes receiving an annotation, applying one or more security rules to detect sensitive information contained in the annotation, and taking one or more security measures in response to detecting sensitive information contained in the annotation.

Another embodiment provides a method of monitoring information contained in annotations. The method generally includes providing security information identifying information considered sensitive, and monitoring the content of annotations for the information considered sensitive.

Another embodiment provides a method of preventing the divulgence of sensitive information in displayed annotations. The method generally includes receiving a request from a user to view an annotation, retrieving the annotation, searching the annotation for information considered sensitive, and in response to detecting information considered sensitive in the annotation, taking one or more security measures.

Another embodiment provides a computer readable medium containing a program for monitoring information contained in annotations. When executed, the program performs operations generally including applying one or more security rules to detect sensitive information contained in an annotation, and taking one or more security measures in response to detecting sensitive information contained in the annotation.

Another embodiment provides a system for managing annotations for data manipulated by one or more type applications. The system generally includes one or more graphical user interface screens for generating annotations, a set of security information identifying information considered sensitive, and an annotation security component. The annotation security component is generally configured to monitor annotations for the information considered sensitive and, in response to detecting information considered sensitive in annotations, take one or more security measures.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an exemplary computing environment in which embodiments of the present invention may be utilized.

FIG. 2 is a client server view of one embodiment of the computing environment of FIG. 1.

FIG. 3 is a relational view of an annotation system according to one embodiment of the present invention.

FIG. 4A is a flow chart illustrating exemplary operations for creating an annotation according to one embodiment of the present invention.

FIGS. 4B-4D illustrate exemplary graphical user interface (GUI) screens in accordance with one embodiment of the present invention.

FIGS. 5A-5D are flow charts illustrating exemplary operations for applying security rules to an annotation according to one embodiment of the present invention.

FIG. 6 is a flow chart illustrating exemplary operations for applying security rules to a requested annotation according to one embodiment of the present invention.

### DETAILED DESCRIPTION OF THE PREFERRED EMBODIMENTS

The present invention provides methods, systems, and articles of manufacture that may be used to prevent sensitive information from being divulged in an annotation. Upon creation and/or modification of an annotation, a set of predefined security rules may be applied to the annotation, in an effort to detect sensitive information contained therein. Upon detecting sensitive information in an annotation, appropriate security measures may be taken, such as notifying a user creating/modifying the annotation (e.g., prompting the user to modify annotation to remove the sensitive information), preventing entry of the annotation, and/or notifying appropriate personnel in charge of security, such as a system administrator.

As used herein, the term sensitive information generally refers to any specified information that is identified as being undesirable to include in an annotation, and the form and type of sensitive information may vary widely among different applications and environment. Specific examples of sensitive information may include identifying information (e.g., names, IDs, social security numbers), other personal information (addresses phone numbers), specified key words, medical diagnoses, and the like.

As used herein, the term annotation generally refers to any type of descriptive information associated with one or more data objects. Annotations may exist in various forms, including textual annotations (descriptions, revisions, clarifications, comments, instructions, etc.), graphical annotations (pictures, symbols, etc.), sound clips, etc. While an annotation may exist in any or all of these forms, to facilitate understanding, embodiments of the present invention may be described below with reference to textual annotations as a particular, but not limiting, example of an annotation. Accordingly, it should be understood that the following techniques described with reference to textual annotations may also be applied to other types of annotations, as well, and, more generally, to any type of reference to a data object.

Further, as used herein, the term user may generally apply to any entity utilizing the annotation system described herein, such as a person (e.g., an individual) interacting with an application program or an application program itself, for example, performing automated tasks. While the following description may often refer to a graphical user interface (GUI) intended to present information to and receive information from a person, it should be understood that in many cases, the same functionality may be provided through a non-graphical user interface, such as a command line and, further, similar information may be exchanged with a non-person user via a programming interface.

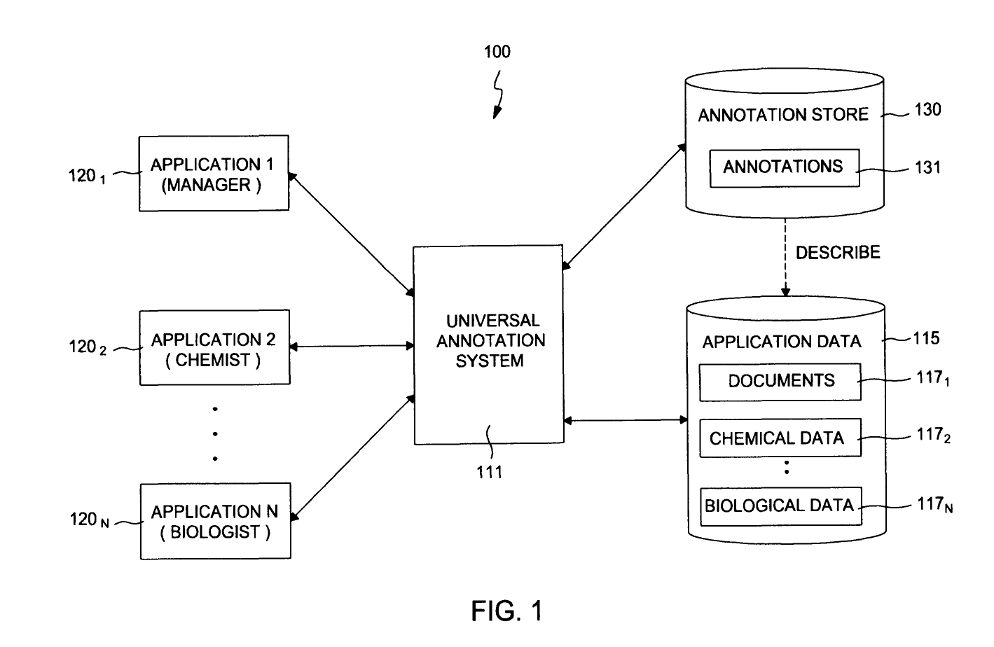

One embodiment of the invention is implemented as a program product for use with a computer system such as, for example, the enterprise system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature

### An Exemplary Environment

FIG. 1 illustrates an exemplary enterprise system 100 deploying a universal annotation system 111 representative of one type of annotation system that may be utilized in accordance with the present invention to exchange information, captured in the form of annotations 131, for example, between users collaborating on a project. In other words, the annotation system 111 may be configured to detect sensitive information in annotations according to techniques described herein. The universal annotation system 111 may be any suitable type annotation system and, for some embodiments, may be similar to the universal annotation system described in the commonly owned, co-pending application entitled “Universal Annotation System,” filed Jun. 18, 2003 (Attorney Docket No. ROC920030209US1), herein incorporated by reference. In any case, the capture process generally involves users (e.g., people or, in some cases, application programs) entering annotation content about some item of “target” data.

As previously described, the target data may be of any suitable type, such as textual or tabular (structured, usually non-textual), graphical, or any other type maintained in any type data source, such as a text document, flow diagram, schematic (e.g., electrical or mechanical) or any multimedia file (e.g, an audio file, image file, or video clip). During the capture process, the user entering the annotation content will typically be interacting with software that could be either embedded within their particular scientific applications (e.g., as a plug-in component) or, alternatively, with a separate annotation application that is external to their scientific applications, for example, a stand-alone browser. The annotations 131 may be stored in a central annotation repository (e.g., an annotation store 130), which may be searched independently or in conjunction with the annotated data, thus allowing users to harvest knowledge captured by other users about the data of interest.

For example, the annotations 131 may capture insights of different users, such as a manager, chemist, and biologist, working in a biomedical enterprise. The annotations 131 may include annotations that describe various type data objects contained in various data sources, such as documents 117₁ (e.g., project status reports) generated by the manager with a first application 120₁ (e.g., a word processor), chemical data 117₂ manipulated (e.g., created/viewed/edited) by the chemist with a second application 120₂ (e.g., a database application), and biological data 117_{N} (e.g., genomic data) generated by a biologist with an N^{th} application 120_{N} (e.g., a database application or specialized genomic data application).

Storing the annotations 131 in the annotation store 130 may allow tacit knowledge to be captured about the data without modifying the data sources containing the data. It should be understood, however, that the annotation store 130 may actually reside on the same system as the annotated data sources. In either case, the various application data 115 are enhanced with the opinions and evaluations of experts (e.g., chemists, biologists, and managers), and this supplementary knowledge is made available to others via the annotation system 111.

As will be described in greater detail below, the annotation system 111 may be integrated with the rest of the enterprise system 100 through an independent annotation browser and plug-in components communicating with a central annotation server, allowing annotations to be manipulated from the same applications 120 used throughout the enterprise to manipulate the annotated data. Thus, the annotation system 111 provides a means for capturing and sharing tacit knowledge that can be analyzed and used in connection with the existing processes, in a wide variety of industries.

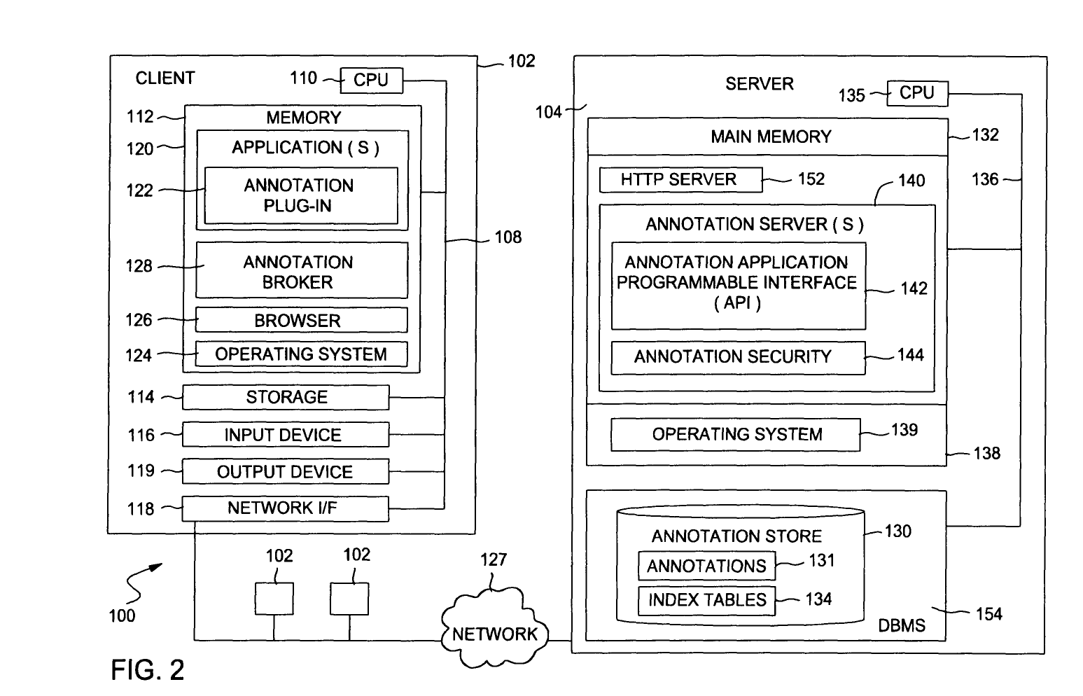

Referring now to FIG. 2, a client-server view of one embodiment of the enterprise system 100 is shown. As illustrated, the system 100 generally includes one or more client computers 102 (e.g., user workstations) generally configured to access annotations 131 in an annotation store 130, via the annotation server 140 (e.g., a software component) running on at least one server computer 104. The client computers 102 and server computer may be connected via a network 127. In general, the network 127 may be any combination of a local area network (LAN), a wide area network (WAN), wireless network, or any other suitable type network, including the Internet.

As illustrated, the client computers 102 generally include a Central Processing Unit (CPU) 110 connected via a bus 108 to a memory 112, storage 114, input devices 116, output devices 119, and a network interface device 118. The input devices 116 may be any devices to give input to the client computer 102, such as a mouse, keyboard, keypad, light-pen, touch-screen, track-ball, or speech recognition unit, audio/video player, and the like. The output devices 119 may be any suitable devices to give output to the user, including speakers and any of various types of display screen. Although shown separately from the input device 116, the output device 119 and input device 116 could be combined (e.g., a display screen with an integrated touch-screen.

The network interface device 118 may be any entry/exit device configured to allow network communications between the client computer 102 and the server computer 104 via the network 127. For example, the network interface device 118 may be a network adapter or other network interface card (NIC). Storage 114 is preferably a Direct Access Storage Device (DASD). Although shown as a single unit, storage 114 may be any combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory (RAM) sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips. Illustratively, the memory 112 contains an operating system 124. Examples of suitable operating systems, which may be used to advantage, include Linux and Microsoft's Windows®, as well as any operating systems designed for handheld devices, such as Palm OS®, Windows® CE, and the like. More generally, any operating system supporting the functions disclosed herein may be used.

The memory 112 is also shown containing at least one application 120 (optionally shown with an associated annotation plug-in 122 and an annotation broker 128). The application 120 may be any of a variety of applications used to manipulate (e.g., create, view, and/or edit) data that may be annotated. For example, the application 120 may be a text editor/word processor used to manipulate annotatable documents, a database application or spreadsheet used to manipulate data, a document generator/viewer (such as Adobe's Acrobat® and Acrobat Reader) used to manipulate documents, or data analysis software, such as Decision Site available from Spotfire, Inc., imaging software used to manipulate images, and any other types of applications used to manipulate various types and forms of data.

Some application programs 120 may be configured to communicate with the annotation server 140 directly, for example, via a set of application programming interface (API) 142 functions provided for the annotation server 140. Other application programs, however, may communicate with the annotation server 140 via plug-in components 122 and/or the annotation broker 128 (e.g. also via the API 142). In other words, annotation capability may be added to an existing application 120 via the plug-in components 122. The plug-in components 122 may, for example, present graphical user interface (GUI) screens to users of applications 120, thus allowing the creation and retrieval of annotations from within the applications used to manipulate the annotated data.

The annotation broker 128 is an optional component and may be implemented as a software component configured to present a standard interface to the Annotation Server 140 from various applications 120, for example, communicating with plug-in components 122 from multiple applications running on the same client computer 102. Hence, the annotation broker 128 may provide a degree of separation between the applications 120 and the annotation server 140, hiding detailed operation of the annotation server 140 and facilitating development of plug-in components 122. In other words, new applications 120 may be supported through the development of plug-in components 122 written in accordance with the annotation broker interface.

Components of the server computer 104 may be physically arranged in a manner similar to those of the client computer 102. For example, the server computer 104 is shown generally comprising a CPU 135, a memory 133, and a storage device 134, coupled to one another by a bus 136, which may all functions as similar components described with reference to the client computer 102. The server computer 104 is generally under the control of an operating system 139 (e.g., IBM OS/400®, UNIX, Microsoft Windows®, and the like) shown residing in memory 133.

As illustrated, the server computer 104 may be configured with the annotation server 140, also shown residing in memory 133. The annotation server 140 provides annotation clients (e.g., running on one or more client computers 102) with access to the annotation store 130, for example, via the annotation API 142. In other words, the annotation API 142 generally defines the interface between annotation clients and the annotation server 140. As used herein, the term annotation client generally refers to any user interface (or other type front-end logic) of the annotation system that communicates with the annotation server to manipulate (e.g., create, update, read and query) annotation data. Examples of annotation clients include applications 120 communicating with the annotation server 140 (directly, or via plug-in components 122) and an annotation browser 126.

As will be described in greater detail below, the annotation server 140 may be configured to perform a variety of operations, such as responding to requests to create annotations for specified data objects, formulating and issuing queries against the annotation store 130 to search for annotations for a specified data object, and formulating and issuing queries against the annotation store 130 to search for annotations satisfying one or more specified conditions (e.g., having a specified author, creation date, content, and the like).

For some embodiments, a distributed annotation system for an enterprise may comprise a plurality of distributed annotation servers 140, for example, each running on a different server computer 104. Each distributed annotation server 140 may support a different set of users (e.g., different departments, or even different geographic locations, within a common enterprise or separate enterprises, etc.), and may maintain a separate annotation store 130. However, each distributed annotation server 140 may be configured to access annotation content from annotation stores 130 maintained by other annotation servers 140 (e.g., directly, or through communication with the corresponding maintaining annotation servers 140), thus allowing annotations to be created and shared by a wide range of users throughout a distributed enterprise.

As illustrated, for some embodiments, the annotation server 140 may include an annotation security component 144. The annotation security component 144 may be configured to detect sensitive information in annotations created or modified via the annotation server 140. For example, as will be described in greater detail below, the annotation security component 144 may be configured to apply a set of predefined security rules to an annotation received from an application 120 of the client 102 in order to detect sensitive information contained therein. For some embodiments, the set of security rules applied and/or security measures taken in response to detecting sensitive information in an annotation may be configurable, for example, by an authorized user, such as a system administrator, thus allowing security to be tailored to the particular needs of an application environment.

### A Relational View of the Annotation System

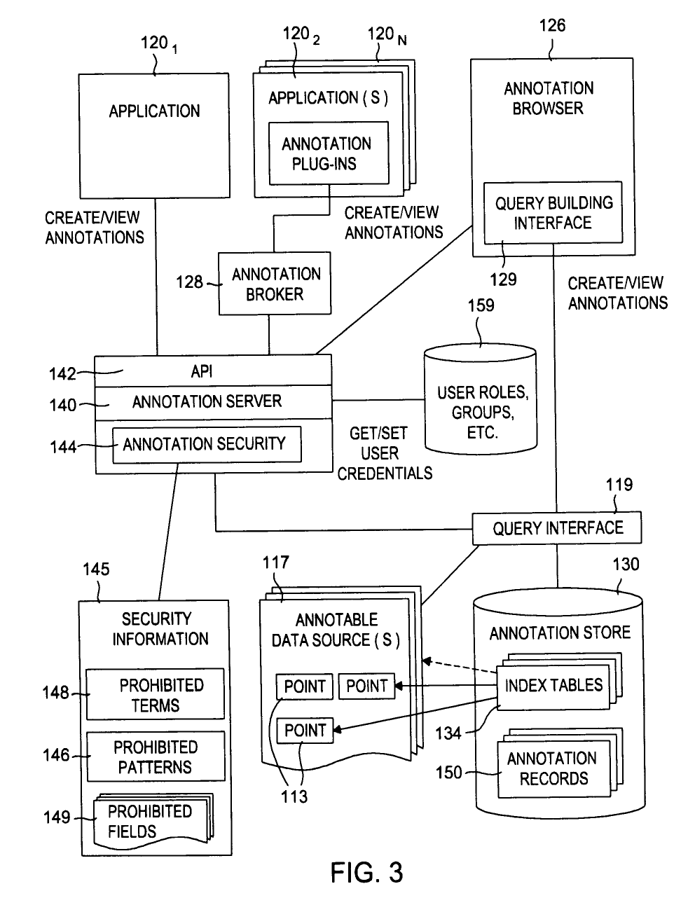

FIG. 3 illustrates a relational view of the annotation server 140 and various other components of the annotation system, in accordance with one embodiment of the present invention. As previously described, one or more applications 120 (e.g., residing on one or more client computers 102) may communicate with the annotation server 140 either directly (e.g., application 120₁) or via the annotation plug-ins 122 and/or annotation broker 128 (e.g., applications 120₂-120_{N}), to create or view annotations for data object manipulated by the applications 120.

As illustrated, the annotation server 140 may issue queries against the annotation store 130 via a query interface 119. For some embodiments, the annotation server 140 may issue abstract queries against the annotation store 130 and the query interface 119 may be an abstract query interface configured to map logical fields of the abstract query to corresponding physical fields of the annotation store 130. The concepts of data abstraction and abstract queries are described in detail in the commonly owned, co-pending application Ser. No. 10/083,075, entitled “Improved Application Portability And Extensibility Through Database Schema And Query Abstraction,” filed Feb. 26, 2002, herein incorporated by reference in its entirety.

As illustrated, the annotation broker 128 may serve as an interface between annotation plug-ins 122 for multiple applications and the annotation server 140. For example, the annotation broker 128 may manage messages sent to and from multiple annotation plug-ins and the annotation server (e.g., providing mediation between multiple plug-in components 122 trying to access the annotation server 140 simultaneously). For some embodiments, the annotation broker 128 may be implemented as a Windows Component Object Model (COM) server that provides a standard interface and facilitates access to the annotation server 140 for annotation plug-ins 122 for Windows applications (e.g., Microsoft Internet Explorer, Microsoft Word, Microsoft Excel, Adobe Acrobat, Spotfire, and other Windows applications). In other words, by providing a standard interface to the annotation server 140, the annotation broker 128 may facilitate extension of the annotation system to support new applications 120 through the development of plug-in components written in accordance with its interface.

As illustrated, an annotation browser 126 may allow the creation and viewing application data and annotations, independently of any of the applications 120. For some embodiments, the annotation browser 126 may provide a generalized web-based user interface for viewing structured data content (e.g. application source data that can be accessed directly through queries via the query interface 119), and for creating and viewing annotations on it. As will be described in greater detail below, for some embodiments, the annotation browser may provide an interface allowing a user to simultaneous query data sources 117 and associated annotations 131.

For some embodiments, in order to identify annotated data object(s), an index, or set of indexes, that may be used to identify the corresponding annotated data object(s) may be stored with the annotation data. As illustrated, an index obtained from an annotation record may be used to retrieve information from one or more index tables 134 that may be used to identify the annotated data object or sub-objects, commonly referred to as annotated points 113. Thus, annotations may be stored in an indexed set of annotation records 150. Examples of suitable techniques for indexing a variety of different type data objects are described in detail in a commonly owned co-pending application, entitled “Heterogeneous Multi-Level Extendable Indexing For General Purpose Annotation Systems,” filed on Jun. 9, 2003 (Attorney Docket No. ROC920030127US1), hereby incorporated by reference.

As used herein, the term “annotatable point” (or simply “point”) may generally refer to any identifiable data unit (or group of data units) capable of being annotated. A point may be defined by a user or exist in context, such as in a sentence or paragraph of a text document. Examples of points include, but are not limited to, database tables, rows, columns, cells, or groups of cells, selected portions of a text document (e.g., defined by an offset and length, start and stop locations, or any other suitable defining information), and the like. Multiple points in an object may be referenced by the same annotation and any point in an object may be referenced by multiple annotations. Further, as indicated by the dashed arrow from the index table 134 in FIG. 3, an annotation may reference points in more than one annotatable data source 117. For some embodiments, additional points may be associated with an annotation, for example, via the annotation API 142, in effect propagating the annotation to the additional points.

In some cases, annotations may also be created and managed that are not associated with any particular point. For example, such annotations may facilitate the capture of insights that are more general in nature than annotation made for specific annotatable points. However, the method and systems described herein may still be utilized to advantage to create, organize, and search such annotations. For example, as described herein with reference to “point-specific” annotations, such annotations may also be created and viewed using one or more annotation structures.

### Annotation Security

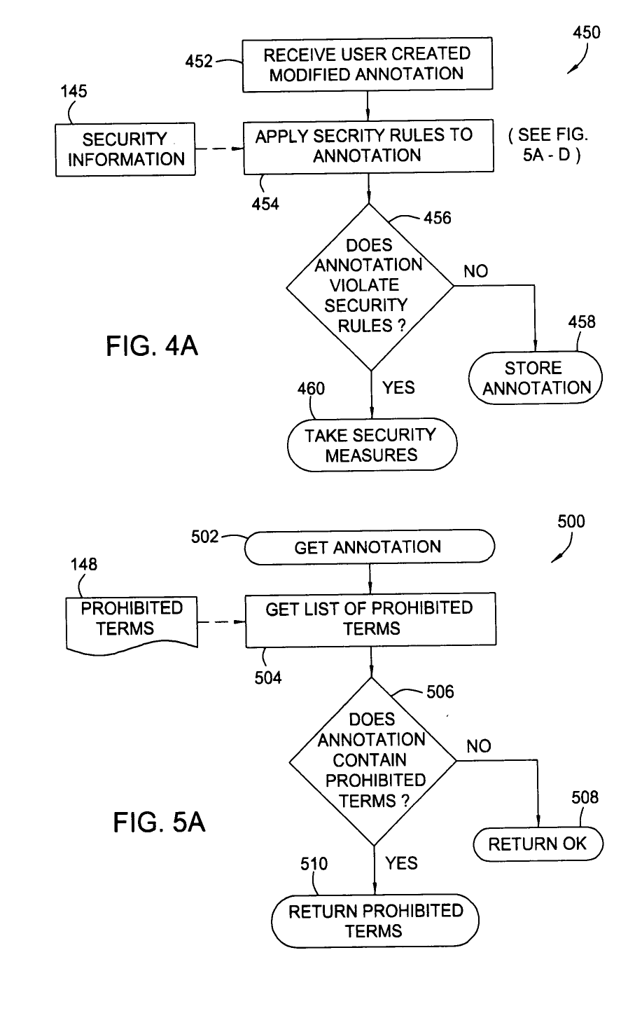

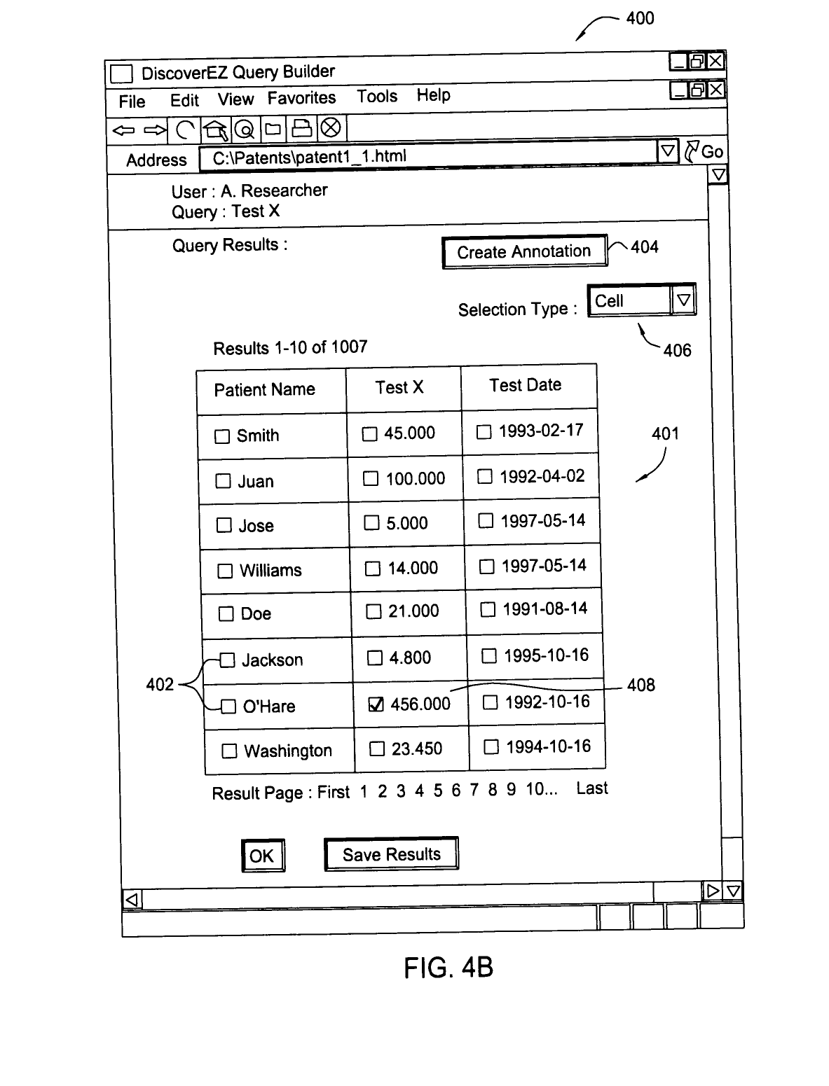

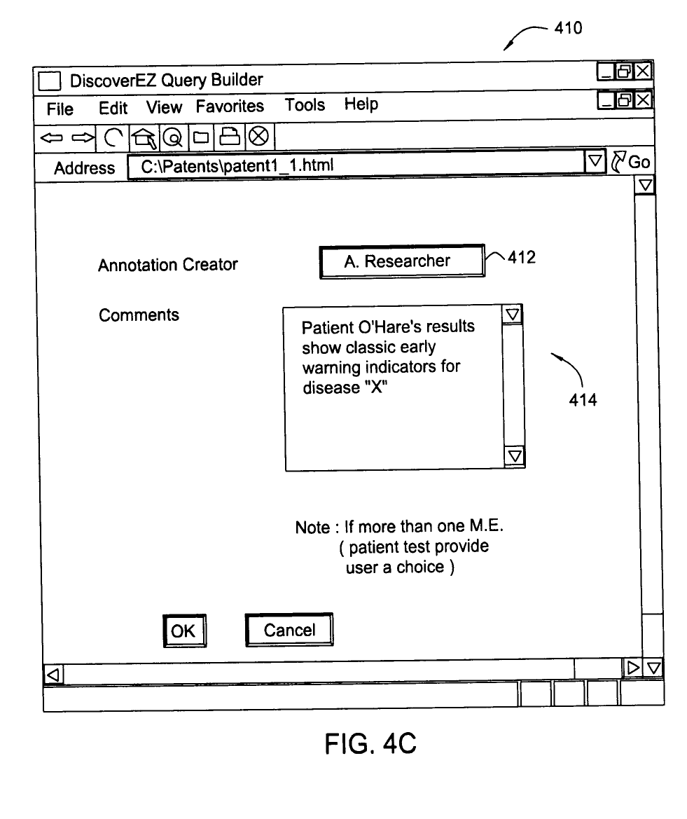

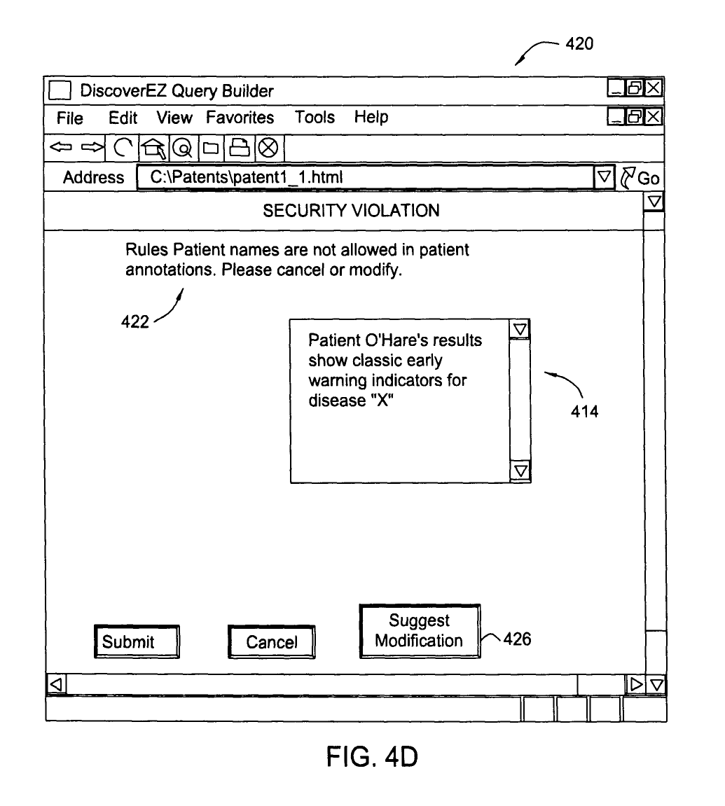

Regardless of the nature of the annotation and the particular data object described by the annotation, the annotation may be examined in order to detect sensitive information contained therein. For example, the annotation security component 144 may be configured to scan the annotation in order to detect sensitive information, as defined by one or more parameters contained in a collection of security information 145. Operation of the annotation security component 144 may best be described with reference to FIG. 4A which illustrates exemplary operations 450 for creating an annotation and FIGS. 4B-4D which illustrate exemplary graphical user interface (GUI) screens 400-420, respectively.

The operations 450 begin, at step 452, by receiving a user-created or modified annotation. For example, the annotation server 140 may receive an annotation created by a user of an application 120, for a portion of a table 401 of query results presented to the user in the GUI screen 410 of FIG. 4B. The table 401 may include a group of cells, each corresponding to a value of a field/column and row of the table 401. As illustrated, a check box 402 may be displayed adjacent each cell value, allowing a user to specify cells for which annotations are to be created. For some embodiments, users may be able to create annotations of differing scope (e.g., describing different data objects), via an Annotation Scope pull-down menu 406. For example, the user may be able to specify a row, column, or table annotation scope, causing similar check boxes 402 to be displayed adjacent the rows, columns, or table, accordingly.

As illustrated, the user may choose to annotate a particular value 408 of a test result, for example, that the user finds particularly relevant (e.g., the results may be particularly high, low, or otherwise interesting). After selecting the check box 402 adjacent the value 408, the user may access the GUI screen 410 of FIG. 4C, for example, via a Create Annotations button 404. The GUI screen 410 may indicate the annotation author at 412 and provide a text box 414 for entering a comment. As illustrated, the user may comment that the annotated test results indicate that the corresponding patient, identified by name, shows classic early warning signs of a disease. As previously described, the patient's name may be sensitive information that should not be included in the annotation.

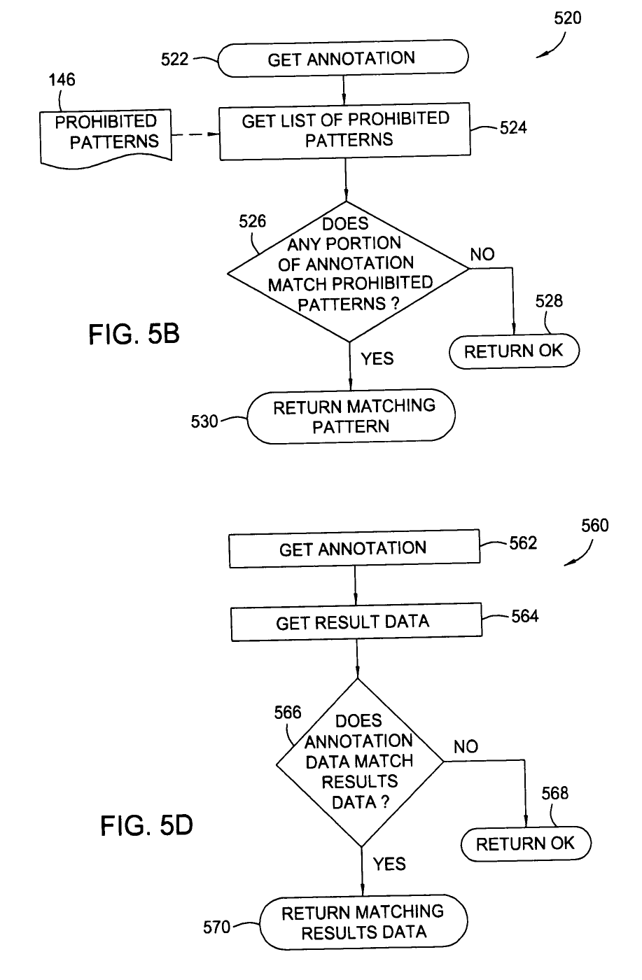

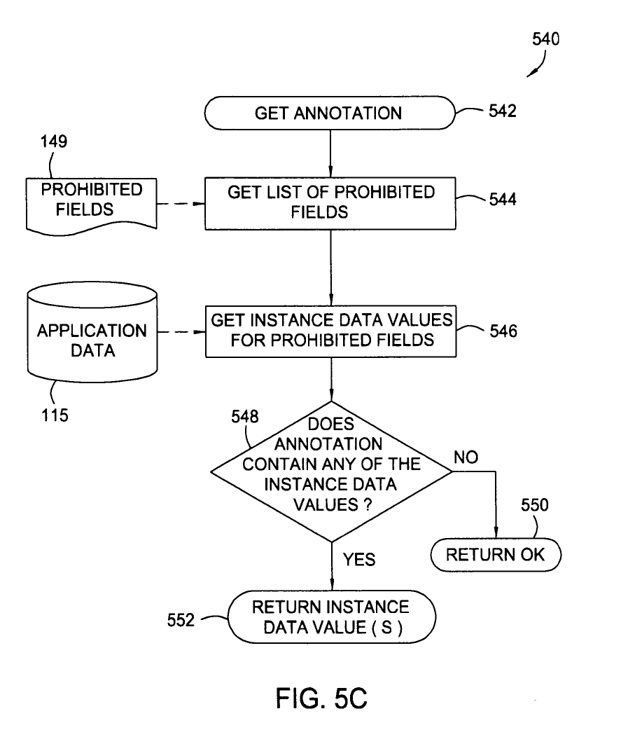

At step 454, security rules are applied to the annotation, for example, in response to the user selecting OK in the GUI screen 410. The security rules may be applied using a collection of security information 145 accessed by the annotation security component 144. As illustrated in FIG. 3, the collection of security information 145 may include a set of prohibited terms 148, a set of prohibited patterns 146, and a set of prohibited fields 149 that may be used to identify what information should be considered sensitive. Exemplary uses of each of these sets of information are described in greater detail below, with reference to FIGS. 5A-5C, and the annotation security component 144 may access any combination of the sets when applying security rules to the annotation.

At step 456, the annotation security component 144 determines if the annotation violates any security rules. If no security violation is detected, the annotation may be stored at step 458, for example, as an indexed annotation record 150 in the annotation store 130 (as shown in FIG. 3). On the other hand, if a security violation is detected, appropriate security measures are taken, at step 460. The particular security measures taken may depend on a particular application and may be configurable, for example, by an administrator. Examples of possible security measures include, but are not limited to, notifying security personnel (e.g., via a network message), preventing the annotation from being entered, and notifying the user (e.g., the annotation author).

For example, the user may be notified via the GUI screen 420 shown in FIG. 4C. As illustrated, a particular security rule violated may be indicated at 422, and the annotation may be displayed in an edit box 414, allowing the user to modify the annotation, for example, in an effort to overcome the rule violation. For some embodiments, an offending portion of the annotation may be highlighted (e.g., the patients name in this example). As illustrated, a user may also be presented with one or more suggested modifications, accessible via a Suggest Modification button 426. For example, the suggested modification may be as simple as removing an offending portion from the annotation. Alternatively, one or more automatically generated annotations (in compliance with the security rules) may be presented from which the user may select. Further, depending on the implementation, the user may simply submit the annotation unmodified, effectively verifying the annotation does not constitute a breach of sensitive information.

### Exemplary Sensitive Information

Information regarded as sensitive may vary widely for different application environments, as well as for different situations within the same application environment. Further, what constitutes sensitive information may depend on information from one or more sources (e.g., a type of document, type of database table, etc.). As previously described with reference to FIG. 3, sensitive information may be identified by a collection of security information 145 including, for example, any combination of prohibited terms 148, prohibited patterns 146, and prohibited fields 149. The security information 145 may be maintained, for example, by an administrator and periodically updated in an effort to stay current and tailor the security information to the needs of a particular application environment. The exact collection of security information utilized to identify what is sensitive in a particular situation may depend on a number of factors, such as a role of the user making the annotation, the particular data being annotated, and/or an application 120 used to manipulate the annotated data (e.g., various sets of information may exist, with different sets used for different situations).

Further, as described in the previously referenced application “Universal Annotation System,” filed Jun. 18, 2003 (Attorney Docket No. ROC920030209US1), different annotations may be created for different purposes and/or intended for viewing by different users, for example, operating in different roles. Therefore, what is considered to be sensitive information may also depend on the type of annotation, as well as a role of the user for which the annotation is intended (e.g., some users, acting in a management role, may be authorized to view certain information, such as formal names, while others may not). Accordingly, annotation content that causes a security violation when included in one type of annotation may not cause a security violation when included in another type of annotation.

FIGS. 5A-5D illustrate how different types of information may be used to determine whether an annotation contains sensitive information. Of course, while shown as separate operations, it should be noted that the operations of the various FIGS. 5A-5D may also be combined in any manner. In other words, the operations of each could be regarded as the application of a single security rule, while any combination of security rules may be applied to an annotation (e.g., as operations of step 454 of FIG. 4A), depending on a particular configuration.

FIG. 5A illustrates exemplary operations 500 for detecting sensitive information based on a set of prohibited terms 148 (e.g., a dictionary of prohibited terms). The operations 500 begin at step 502, by receiving an annotation. For example, the annotation server 140 may receive an annotation and pass it on to the annotation security component 144 to be tested. At step 504, a list of prohibited terms 148 is obtained. As an example, the list of prohibited terms may contain a list of any types of terms that are considered sensitive and, therefore, should not be allowed in annotations (at least without some consideration), such as formal names or any specified key words. For example, in a medical environment, certain key words related to diagnoses may compromise a patient's security. Further, as previously described, the exact set of prohibited terms obtained may depend on a role of the user creating the annotation, a role of the intended reader of the annotation and/or a type of the annotation.

In either case, at step 506, a determination is made, as to whether the annotation contains one or more of the prohibited terms. If not, an “OK” result is returned, at step 508. Otherwise, an indication the annotation contains one or more of the prohibited terms may be provided, for example, by returning the one or more prohibited terms, at step 510. As an example, in the example illustrated in FIGS. 4B-4D, the formal patient name O'Hare may included in the list of prohibited terms, and returned, at step 510, for example, allowing display to the user (e.g., in the GUI screen 420). Of course, for some embodiments, rather than a rigid set of prohibited terms, one or more algorithms may be used, for example, to effectively expand the set of prohibited terms based on synonym searching (e.g., cancer may be expanded to tumor, malignant, and the like).

FIG. 5B illustrates exemplary operations 520 for detecting sensitive information based on a set of prohibited patterns 146. For example, the prohibited patterns may include a set of templates that identify common formats of information deemed sensitive, such as social security numbers (e.g., a nine digit numerical entry), telephone numbers (e.g., seven or ten digits for U.S. telephone numbers), ID formats (e.g., an institution may use eight digit alphanumeric non-words as IDs), and the like.

The operations 520 begin at step 522, by receiving an annotation and, at step 524, a list of prohibited patterns 146 is obtained. At step 526, a determination is made, as to whether any portion of the annotation matches one of the prohibited patterns, for example, utilizing any suitable technique for parsing the annotation and searching for patterns. If no match is found, an “OK” result is returned, at step 528. Otherwise, an indication of a match is provided, for example, by returning one or more prohibited patterns occurring in the annotation, at step 530.

FIG. 5C illustrates exemplary operations 540 for detecting sensitive information based on a set of prohibited fields 149. The prohibited fields 149 may include any fields (generally referring to any annotatable portion of data) that may include information regarded as sensitive (e.g., an ID field, social security number field, name field, and the like). In other words, instance data values associated with the prohibited fields (e.g., field entries for a particular row) may be considered sensitive and treated in a similar manner to prohibited terms, as described above (in fact, for some embodiments, a set of prohibited terms 148 may be generated by querying a set of prohibited fields). As an example, an annotation rule applied to an annotation made for a lab test field might identify social security numbers, names, and Diagnoses as prohibited fields.

The operations 540 begin at step 542, by receiving an annotation and, at step 544, the list of prohibited fields 149 is obtained. At step 546, instance data values for the prohibited fields are obtained, for example, by issuing one or more queries specifying the prohibited fields as results. At step 548, a determination is made, as to whether the annotation contains any of the instance data values occurring in the prohibited fields. If not, an “OK” result is returned, at step 550. Otherwise, an indication of a match is provided, for example, by returning the one or more instance data values (and possibly the associated prohibited field), at step 552.

For some embodiments, the names of prohibited fields may also be considered sensitive information, for example, to prevent divulgence of what data was being considered at the time the annotation was created. For possibly similar reasons, for some embodiments, the actual results data being viewed at the time the annotation is created, particularly data occurring in the same row, may be regarded sensitive, as illustrated in the exemplary operations 560 of FIG. 5D. At step 562, an annotation is obtained and, at step 564, the results data (e.g., a portion of which is described by the annotation) is obtained. At step 566, a determination is made, as to whether any portion of the annotation contents matches any portion of the results data (e.g., whether the annotation is “contaminated” with the results data). If not, an “OK” result is returned, at step 568. Otherwise, an indication of the match is provided, for example, by returning the matching results data, at step 570.

### Applying Security for Annotation Retrieval

In addition to applying security rules when an annotation is created, annotation rules may also be applied when a request is made to retrieve (e.g., to view) an annotation. For example, as previously described, what is considered sensitive information may be determined, at least in part, based on a user's role (or some other credential, such as a user ID, member group, etc.). Therefore, security measures may be applied during annotation retrieval, for example, to prevent a requesting user from viewing information considered sensitive to that individual (e.g., information the individual is not authorized to view). For some embodiments, the user may be requesting an annotation to which annotation security rules were not applied during creation, thereby allowing sensitive information to be contained in the annotation.

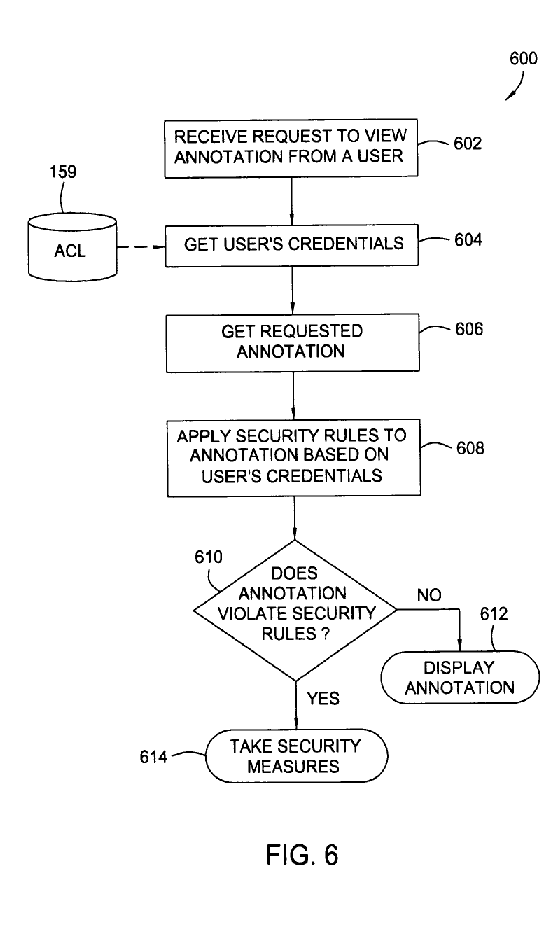

FIG. 6 illustrates exemplary operations 600 for performing annotation security during annotation retrieval. At step 602, a request to view an annotation is received from a user. At step 604, the user's credentials are obtained (for example, from an access control list 159 containing user IDs, roles, security levels, groups, etc., shown in FIG. 3). At step 606, the requested annotation is obtained and, at step 608, security rules are applied to the annotation based on the user's credentials. For example, any of the operations described above for determining whether an annotation contained sensitive (e.g., prohibited) information may be applied to the annotation, whereby the information determined to be sensitive may depend on the user's credentials. For example, a set of prohibited terms 148, prohibited patterns 146, or prohibited fields 149, may be selected based on the user's credentials.

In any case, at step 610, a determination is made as to whether the annotation violates the security rules. If not, the annotation is displayed to the user, at step 612. Otherwise, security measures are taken at step 614. For example, the user may be notified he is not authorized to view the annotation and/or security personnel may be notified that an unauthorized user is attempting to access an annotation containing sensitive information.

### Conclusion

By applying one or more security rules to annotations, embodiments of the present invention may be utilized to prevent sensitive information from being divulged thereby. The one or more security rules may be applied upon creation and/or modification of an annotation, as well as during retrieval of the annotation. Upon detecting sensitive information in an annotation, appropriate security measures may be taken, such as notifying a user accessing (e.g., creating, modifying, or retrieving) the annotation and/or notifying appropriate personnel in charge of security, such as a system administrator.

While the foregoing is directed to embodiments of the present invention, other and further embodiments of the invention may be devised without departing from the basic scope thereof, and the scope thereof is determined by the claims that follow.

1. A method of preventing sensitive information from being divulged in annotations, comprising:
receiving an annotation;
applying one or more security rules to detect sensitive information contained in the annotation; and
taking one or more security measures in response to detecting sensitive information contained in the annotation.

2. The method of claim 1, wherein:
receiving the annotation comprises receiving the annotation from a user; and
the one or more security rules applied are determined, at least in part, based on a credential of the user.

3. The method of claim 1, wherein applying one or more security rules comprises:
obtaining a set of specified terms; and
searching the annotation for one or more of the specified terms.

4. The method of claim 1, wherein applying one or more security rules comprises:
obtaining a set of specified patterns; and
searching the annotation for data matching one or more of the specified patterns.

5. The method of claim 1, wherein applying one or more security rules comprises:
obtaining a set of specified fields;
obtaining instance values of data contained in the specified fields; and
searching the annotation for one or more of the instance values.

6. The method of claim 5, wherein obtaining instance values of data contained in the specified fields comprises issuing queries against a database containing data described by the annotation.

7. The method of claim 1, wherein:
the annotation describes a first portion of query results; and
applying one or more security rules comprises searching the annotation for data contained in a second portion of the query results.

8. The method of claim 7, wherein the first and second portions of the query results are contained in a common row of data.

9. The method of claim 1, wherein taking one or more security measures comprises notifying a user sensitive information has been detected in the annotation.

10. The method of claim 9, further comprising allowing the user to modify the annotation.

11. The method of claim 9, further comprising allowing the user to store the annotation without modification.

12. The method of claim 9, further comprising suggesting a modification to the annotation.

13. The method of claim 1, wherein taking one or more security measures comprises notifying security personnel.

14. A method of monitoring information contained in annotations, comprising:
providing security information identifying information considered sensitive; and
monitoring the content of annotations for the information considered sensitive.

15. The method of claim 14, wherein the security information comprises at least one of: a set of prohibited terms, a set of prohibited patterns, and a set of prohibited fields.

16. The method of claim 15, wherein monitoring the content of annotations for the information considered sensitive comprises at least two of:
monitoring the content of annotations for one or more of the prohibited terms;
monitoring the content of annotations for data matching one or more of the prohibited patterns; and
monitoring the content of annotations for one or more instance values of data contained in one or more of the prohibited fields.

17. The method of claim 16, wherein monitoring the content of annotations for one or more instance values of data contained in one or more of the prohibited fields comprising querying a database containing the instance values and data described by the annotation.

18. A method of preventing the divulgence of sensitive information in displayed annotations, comprising:
receiving a request from a user to view an annotation;
retrieving the annotation;
searching the annotation for information considered sensitive; and
in response to detecting information considered sensitive in the annotation, taking one or more security measures.

19. The method of claim 18, wherein information considered sensitive is determined, at least in part, based on one or more credentials of the user.

20. The method of claim 19, wherein, the user is not authorized to view the information considered sensitive.

21. The method of claim 20, wherein taking one or more security measures comprises providing an indication the user is unauthorized to view information contained in the annotation.

22. A computer readable medium containing a program for monitoring information contained in annotations which, when executed, performs operations, comprising:
applying one or more security rules to detect sensitive information contained in an annotation; and
taking one or more security measures in response to detecting sensitive information contained in the annotation.

23. The computer readable medium of claim 22, wherein the operations further comprise providing one or more graphical user interface screens for generating the annotation.

24. The computer readable medium of claim 22, wherein taking one or more security measures comprises providing one or more graphical user interface screens notifying a user sensitive information contained in the annotation has been detected.

25. The computer readable medium of claim 24, wherein the one or more graphical user interface screens notifying the user sensitive information contained in the annotation has been detected provides an indication, to the user, of the sensitive information.

26. The computer readable medium of claim 24, wherein the one or more graphical user interface screens notifying the user sensitive information contained in the annotation has been detected allows the user to modify the annotation.

27. The computer readable medium of claim 24, wherein the one or more graphical user interface screens notifying the user sensitive information contained in the annotation has been detected provides one or more suggested modifications to the annotation.

28. The computer readable medium of claim 22, wherein the one or more security rules are applied in response to the user submitting the annotation.

29. The computer readable medium of claim 22, wherein applying one or more security rules to detect sensitive information contained in an annotation comprises at least one of:
searching the annotation for one or more prohibited terms;
searching the annotation for data matching one or more prohibited patterns;
searching the annotation for one or more instance values of data contained in one or more of the prohibited fields; and
searching the annotation for one or more instance values of data contained in query results containing data described by the annotation.

30. An system for managing annotations for data manipulated by one or more type applications, comprising:
one or more graphical user interface screens for generating annotations;
a set of security information identifying information considered sensitive; and
an annotation security component configured to monitor annotations for the information considered sensitive and, in response to detecting information considered sensitive in annotations, take one or more security measures.

31. The system of claim 30, further comprising a set of plug-in components, each for interfacing between one or more applications and the system.

32. The system of claim 30, wherein:
the set of security information comprises a set of prohibited terms considered sensitive; and
the annotation security component is configured to search annotations for the occurrence of the prohibited terms.

33. The system of claim 30, wherein:
the set of security information comprises a set of prohibited fields associated with data considered sensitive; and
the annotation security component is configured to query a database for instance values contained in the prohibited fields and search annotations for the instance values.

34. The system of claim 30, wherein:
the set of security information comprises a set of prohibited patterns associated with data considered sensitive; and
the annotation security component is configured to search annotations for data matching the prohibited patterns.

35. The system of claim 30, wherein the annotation security component is configured to monitor annotations for different sets of information considered sensitive based, at least in part, on one or more credentials of an annotation author.

36. The system of claim 30, wherein:
the one or more graphical user interface screens for generating annotations allow different types of annotations to be generated; and
the annotation security component is configured to monitor annotations for different sets of information considered sensitive based, at least in part, on the different types of annotations.

37. The system of claim 30, wherein the one or more security measures comprise at least one of:
notifying a user information considered sensitive has been detected in an annotation; and
notifying security personnel information considered sensitive has been detected in an annotation.
